(19) United States
(12) Patent Application Publication
(10) Pub. No.: US 2007/0092653 A1
(43) Pub. Date: Apr. 26, 2007

(54) Method for improving application consistency for waterborne effect coating compositions

(76) Inventors: Carl J. Long II, Johnson City, TN (US); Lisa R. Dillard, Kingsport, TN (US)

Correspondence Address: Polly C. Owen;Eastman Chemical Company, P.O. Box 511, Kingsport, TN, 37662-5075, US

(21) Appl. No.: 11/368,888

(22) Filed: Mar. 6, 2006

Related U.S. Application Data
(60) Provisional application No. 60/730,450, filed on Oct. 26, 2005.

(51) Int. Cl. B05D 3/04

(52) U.S. Cl. 427/339

(57) ABSTRACT

Waterborne effect coating compositions comprising carboxyalkyl cellulose esters have been demonstrated to yield improved and more consistent appearance than control compositions when applied under a wide range of temperature and humidity conditions.

### CROSS-REFERENCE TO RELATED APPLICATIONS

This application claims priority to U.S. Provisional Application Ser. No. 60/730,450 filed Oct. 26, 2005, the disclosure of which is incorporated herein by reference in its entirety.

### BACKGROUND OF THE INVENTION

It is well known that effect pigments in coating compositions can provide appearance attributes to coated articles that are attractive to consumers. Of particular interest are metallic and pearlescent finishes that can be applied to automobiles, high-end appliances, and consumer electronics devices. These coatings must provide for adequate orientation of the effect pigments, which typically exist as high-aspect ratio pigment flakes, relative to the surface of the substrate such that a perception of depth is created by light reflected from the oriented flakes. For optimum appearance and maximum efficiency in the use of the expensive effect pigments, it is critical that the pigment flakes be oriented near-parallel to the surface of the substrate during the application process and that this orientation be maintained or even enhanced as the coating dries.

Due to environmental concerns, and, in some cases, legislation, there is significant interest in the development of waterborne coating formulations which are capable of delivering on performance comparable to that of solvent-borne systems while reducing the level of volatile organic compounds (VOC) in the coating formulation. One significant issue that continues to plague waterborne coatings in general and waterborne effect coatings in particular is the sensitivity of the appearance of the coating to the prevailing temperature and relative humidity conditions under which the coating is applied and cured.

For a solvent-borne coating, the rate at which the applied coating film dries is primarily dependent on temperature and essentially independent of relative humidity. This is due to the fact that relative humidity has little effect on the capacity of air for volatile solvent(s). However, the capacity of air for water, which is often the majority component of a waterborne coating formulation, is inversely proportional to its relative humidity. Therefore, under high humidity conditions, a waterborne coating will remain fluid or “wet” for a longer period of time thereby allowing more time for defects in the final coating film to occur. This problem can be exacerbated as the temperature of the application environment increases at high humidity. Not only does the evaporation of the water in the coating composition remain slow at high relative humidity; but the viscosity of the applied coating composition will decrease with the increasing temperature. The result is a prolonged period of mobility for the pigment flakes that are dispersed in the coating composition such that Brownian motion can cause them to become disoriented relative to the substrate surface. This in turn often yields a dramatic reduction in the overall brightness or apparent depth of the coating. Furthermore, variability in the appearance of the coating may result as areas of the coating film with slightly different thicknesses dry at slightly different rates thereby yielding a mottling effect. The collective result of these factors is that, as was mentioned previously, the appearance of waterborne effect coatings can be significantly impacted by even minimal, though routine, variations of the environmental conditions under which they are applied.

Numerous mechanical solutions have been proposed to ensure that the environmental conditions under which a waterborne coating composition is applied are very well controlled. Other mechanical solutions have been proposed in which the composition of the waterborne effect coating is adjusted in real-time to compensate for measured changes in the application environment. While these mechanical solutions may be attractive for the construction of new coating application facilities, they are very expensive relative to standard coating application equipment. Furthermore, they are often impractical for consideration and installation in existing coating application facilities.

Therefore, there is a need in the industry for a waterborne coating composition which can be applied using a range of application methods and that has a consistency in appearance across both a wide range of temperature and relative humidity.

### BRIEF SUMMARY OF THE INVENTION

An object of the present invention is to improve the consistency of appearance of waterborne effect coating compositions when they are applied across a wide range of temperature and relative humidity.

Another object of the present invention is to provide an article comprising the waterborne effect coating composition.

In accordance with one embodiment of the present invention, a method for improving the consistency of appearance of a waterborne effect coating composition is provided. The method comprises: 1) maintaining the temperature of an application environment within a range of from about 50° F. to about 90° F., 2) maintaining the relative humidity of the application environment within a range of from about 40% to about 90%, and 3) applying to a substrate the waterborne effect coating composition; wherein the waterborne effect coating composition comprises at least one waterborne film-forming resin, at least one effect pigment, and at least one carboxyalkyl cellulose ester.

In accordance with another embodiment of the invention, an article comprising the waterborne effect coating composition is also provided.

### DETAILED DESCRIPTION

Before the present methods and articles are disclosed and described, it is to be understood that this invention is not limited to specific methods or to particular formulations, except as indicated, and as such, may vary from the disclosure. It is also to be understood that the terminology used is for the purpose of describing particular embodiments only, and is not intended to limit the scope of the invention.

The singular forms “a,” “an,” and “the” include plural referents, unless the context clearly dictates otherwise.

Optional or optionally means that the subsequently described event or circumstances may or may not occur. The description includes instances where the event or circumstance occurs, and instances where it does not occur.

Ranges may be expressed herein as from about one particular value, and/or to about another particular value. When such a range is expressed, it is to be understood that another embodiment is from the one particular value and/or to the other particular value, along with all combinations within said range.

Throughout this application, where patents or publications are referenced, the disclosures of these references in their entireties are intended to be incorporated by reference into this application, in order to more fully describe the state of the art to which the invention pertains to the extent the reference(s) does not contradict the statements made herein.

The terms “application consistency” and “application robustness” are used interchangeably and mean that the waterborne effect coating composition comprising a waterborne film-forming resin, effect pigment, and carboxyalkyl cellulose ester has less variability in appearance than a waterborne effect coating composition without the carboxyalkyl cellulose ester. Variability in the appearance across a range of application conditions is assessed by averaging the values of face brightness (typically, L* at an angle of 15 degrees aspecular on a multi-angle spectrophotometer) that are measured for each application condition and calculating a standard deviation in appearance associated with the changing application conditions. “Less variability” means that said standard deviation in appearance is less for the waterborne effect coating composition containing carboxyalkyl cellulose ester than is the standard deviation of a waterborne effect coating composition without carboxyalkyl cellulose ester when it is calculated from face brightness measurements obtained under the same range of application conditions.

In one embodiment of the invention, a method for improving the consistency of appearance of a waterborne effect coating composition is provided. The method comprises:
1 ) maintaining the temperature of an application environment within a range of from about 50° F. to about 90° F.,
2) maintaining the relative humidity of the application environment within a range of from about 40% to about 90%, and
3) applying to a substrate the waterborne effect coating composition; wherein the waterborne effect coating composition comprises at least one waterborne film-forming resin, at least one effect pigment, and at least one carboxyalkyl cellulose ester.

The waterborne effect coating composition can be applied by any method known in the art. For example, the waterborne effect coating composition can be applied by brushing, dipping, roll coating (direct and reverse), printing (gravure, flexographic, and screen), and spraying. It is especially preferred that the coating composition be applied to the substrate by spraying.

The carboxyalkyl cellulose ester can be any that is known in the art for use in coating compositions. In one embodiment of the invention, the carboxyalkyl cellulose esters are certain esters of carboxy(C₁-C₃ alkyl) cellulose, which are useful as binder components of coating compositions. Such esters can have an inherent viscosity of about 0.20 to about 0.70 dL/g or from about 0.35 to about 0.60 dL/g, as measured in a 60/40 (wt./wt.) solution of phenol/tetrachloroethane at 25° C. The carboxyalkyl cellulose esters can also have a degree of substitution per anhydroglycose unit of carboxy(C₁-C₃ alkyl) of about 0.20 to 0.75, and a degree of substitution per anhydroglucose unit of C₂-C₄ esters of about 1.5 to about 2.7.

In another embodiment of the present invention, the carboxyalkyl cellulose ester is a carboxymethyl cellulose butyrate having a degree of substitution per anhydroglucose unit of carboxymethyl of about 0.20 to about 0.75, a degree of substitution per anhydroglucose unit of hydroxyl from about about 0.10 to about 0.70, and a degree of substitution per anhydroglucose unit of butyryl of about 1.50 to about 2.70, and having an inherent viscosity of about 0.20 to about 0.70 dL/g, as measured in a 60/40 (wt./wt.) solution of phenol/tetrachloroethane at 25° C. Another range for the degree of substitution per anhydroglucose unit of carboxymethyl is about 0.25 to about 0.35. Another range for the inherent viscosity of this carboxyalkyl cellulose ester is from about 0.35 to about 0.60 dL/g.

In another embodiment of the present invention, the carboxyalkyl cellulose ester is a carboxymethyl cellulose propionate having a degree of substitution per anhydroglucose unit of carboxymethyl of about 0.20 to about 0.75, a degree of substitution per anhydroglucose unit of hydroxyl from about 0.10 to about 0.70, and a degree of substitution per anhydroglucose unit of propionyl of about 1.50 to about 2.70, and having an inherent viscosity of about 0.20 to about 0.70 dL/g, as measured in a 60/40 (wt./wt.) solution of phenol/tetrachloroethane at 25° C. Another range for the degree of substitution per anhydroglucose unit of carboxymethyl of the carboxymethyl cellulose propionate is about 0.25 to about 0.35. Another range for the inherent viscosity of this carboxymethyl cellulose propionate is from about 0.35 to about 0.60 dL/g.

As a further embodiment, the carboxyalkyl cellulose ester can be a carboxymethyl cellulose acetate butyrate having a degree of substitution of carboxymethyl of about 0.20 to about 0.75, preferably 0.25 to 0.35, a degree of substitution per anhydroglucose unit of hydroxyl from about 0.10 to about 0.70, and a degree of substitution per anhydroglucose unit of butyryl of about 0.10 to about 2.60 and a degree of substitution per anhydroglucose unit of acetyl of about 0.10 to about 1.65, and having an inherent viscosity of about 0.20 to about 0.70 dL/g, as measured in a 60/40 (wt./wt.) solution of phenol/tetrachloroethane at 25° C. Another range for the inherent viscosity of the carboxymethyl cellulose acetate butyrate is from about 0.35 to about 0.60 dL/g. Another range for the degree of substitution per anhydroglucose unit of hydroxyl is from about 0.10 to about 0.70, butyryl is about 1.10 to about 2.55, and acetyl is about 0.10 to about 0.90.

As a further embodiment, the carboxylalkyl cellulose ester can be a carboxymethyl cellulose acetate propionate having a degree of substitution per anhydroglucose unit of carboxymethyl of about 0.20 to about 0.75, a degree of substitution per anhydroglucose unit of hydroxyl from about 0.10 to about 0.70, and a degree of substitution per anhydroglucose unit of propionyl of about 0.10 to about 2.60 and a degree of substitution per anhydroglucose unit of acetyl of about 0.10 to about 2.65, and having an inherent viscosity of about 0.20 to about 0.70 dL/g, as measured in a 60/40 (wt./wt.) solution of phenol/tetrachloroethane at 25° C. Another range for the inherent viscosity of this carboxymethyl cellulose acetate propionate is from about 0.35 to about 0.60 dL/g. Another range for the degree of substitution per anhydroglucose unit of carboxymethyl is from about 0.25 to about 0.35. Another range for the degree of substitution per anhydroglucose unit of hydroxyl in the carboxymethyl cellulose acetate propionate is from about 0.10 to about 0.70, butyryl is about 1.10 to about 2.55, and acetyl is about 0.10 to about 0.90.

The carboxy(C₁-C₃)alkyl cellulose esters may be prepared by a multi-step process. In this process, the free acid form of, for example, carboxymethyl cellulose is water activated followed by water displacement via solvent exchange with an alkanoic acid such as acetic acid followed by treatment with a higher aliphatic acid (propionic acid or butyric acid) to give a carboxymethyl cellulose (CMC-H) activate wet with the appropriate aliphatic acid. It is preferred that the starting carboxymethyl cellulose be prepared from cellulose with a 95 to 99% alpha content, preferably about 96 to 97% alpha cellulose content. The high alpha content is important for the quality of the final products prepared therefrom. Low alpha cellulose pulps lead to poor solubility in organic solvents and consequently poor formulations.

Next, the CMC-H is treated with the desired anhydride in the presence of a strong acid catalyst such as sulfuric acid to give a fully substituted CMC ester. A final solution (consisting of water and an aliphatic acid) is added slowly to the anhydrous “dope” solution so as to allow removal of combined sulfur from the cellulose backbone. The final addition allows a slow transition through the hydrous point to give period of low water concentration and high temperature (as a result of the exotherm from water reacting with excess anhydride) in the reaction medium. This step causes the hydrolysis of combined sulfur from the cellulose backbone. This product is then hydrolyzed using sulfuric acid to provide a partially substituted carboxymethyl cellulose ester. Hydrolysis can provide gel free solutions in organic solvents and can provide better compatibility with other resins in coatings applications.

Next, the sulfuric acid is neutralized after the esterification or hydrolysis reactions are complete by addition of a stoichiometric amount of an alkali or alkaline earth metal alkanoate, for example, magnesium acetate, dissolved in water and an alkanoic acid such as acetic acid. Neutralization of the strong acid catalyst is important for optimal thermal and hydrolytic stability of the final product.

Finally, either the fully substituted or partially hydrolyzed forms of carboxy(C₁-C₃ alkyl) cellulose ester are isolated by diluting the final neutralized “dope” with an equal volume of acetic acid followed by precipitation of the diluted “dope” into a volume of water about 1.5 to 3.0 times its weight. This is followed by addition of 1.5 to 3.0 volumes of water to give a particle that can be easily washed with de-ionized water to efficiently remove residual organic acids and inorganic salts.

In another embodiment of this invention, the carboxyalkyl cellulose esters utilized in this invention having an inherent viscosity of about 0.2 to about 0.70 dL/g, as measured in a 60/40 (wt./wt.) solution of phenol/tetrachloroethane at25° C. and having a degree of substitution per anhydroglucose unit (DS/AGU) of carboxy(C₁-C₃ alkyl) of about 0.20 to about 0.75 can be produced by a process comprising:
(a) slurrying water wet carboxy(C₁-C₃ alkyl) cellulose (acid form) in a solvent selected from the group consisting of acetic acid, propionic acid, and butyric acid, and mixtures thereof, thereby dewatering the carboxy(C₁-C₃ alkyl) cellulose to form a mixture; followed by
(b) treating the mixture with a compound selected from the group consisting of acetic anhydride, propionic anhydride, and butyric anhydride, and mixtures thereof, in the presence of a strong acid catalyst; followed by
(c) heating at a temperature of about 40° C. to about 55° C. until the reaction is complete, i.e., after complete dissolution of material; followed by
(d) adding slowly a mixture of water, an alkanoic acid and optionally an amount of a C₂-C₅ alkanoic acid salt of an alkali or alkaline earth metal insufficient to totally neutralize the strong acid catalyst;
(e) heating the solution at a temperature of about 55° C. to about 85° C. for about 1 to 15 hours, which effects partial hydrolysis of the carboxy(C₁-C₃ alkyl) cellulose alkanoic ester; and
(f) treating the solution with an equimolar amount, based on the amount of strong acid catalyst, of a C₂-C₅ alkanoic salt of an alkali or alkaline earth metal dissolved in water and an alkanoic acid.

In another embodiment of this process, the reaction mixture is diluted with an equal volume of acetic acid, followed by precipitation of the diluted product into a volume of water about 1.5 to 3.0 times its weight, followed by an additional volume of water about 1.5 to 3.0 times its weight, washed with deionized water and dried to provide the desired product as a powder. This powder is thus free from any significant amount of residual organic acids and inorganic salts.

Carboxyalkyl cellulose esters are further described in U.S. Pat. No. 5,668,273, herein incorporated by reference.

The amount of carboxylalkyl cellulose ester present in the coating composition sufficient to yield the benefit of improved application robustness will depend primarily upon the resin system chosen for the coating but may also be influenced by other coating additives that may be present in the system, in particular, dispersants, rheology control agents, and cosolvents.

In one embodiment of the invention, the coating composition can contain in the range of from about 0.5 to about 50 weight percent carboxylalkyl cellulose ester based on the total solid weight of carboxylalkyl cellulose ester and waterborne film-forming resin. In another embodiment of the invention, the amount of carboxyalkyl cellulose ester is present in the range of from about 0.5 to about 30 weight percent based on total solid weight of carboxylalkyl cellulose ester and waterborne film-forming resin. In another embodiment of the invention, the amount of carboxyalkyl cellulose ester is present in the range of from about 1 to about 15 weight percent based on total solid weight of carboxylalkyl cellulose ester and waterborne film-forming resin.

In another embodiment of the invention, the carboxylalkyl cellulose ester can be provided as an aqueous dispersion. Dispersions of the carboxylalkyl cellulose ester in water can require about 25% to about 100% neutralization of the pendant carboxylate groups with an amine. Typical amines include, but are not limited to, ammonia, piperdine, 4-ethylmorpholine, diethyanolamine, triethanolamine, ethanolamine, tributylamine, dibutylamine, and dimethylamino ethanol.

The waterborne film-forming resin of the present invention may be water-soluble or water-dispersible. The waterborne film-forming resin can be at least one selected from the group consisting of a thermoplastic resin and a thermosetting resin. Examples of thermoplastic resins include, but are not limited to, acrylic polymers, styrene-acrylic polymers, and polyurethane polymers. Thermosetting resins typically comprise a crosslinkable polymer resin and a curative or crosslinking agent. Examples of crosslinkable polymer resins include, but are not limited to, polyester polyols, acrylic polyols, styrene-acrylic polyols, polyurethane polyols, and epoxy resins. Examples of curatives or crosslinking agents include, but are not limited to, melamine-formaldehyde resins, urea-formaldehyde resins, multi-functional isocyanates, and multi-functional amines. In some cases, the thermosetting resin may be what is typically referred to as a self-crosslinking polymer. With a self-crosslinking polymer there is no separate curative or crosslinking agent that must be added to the waterborne film-forming resin in order to yield a fully crosslinked film.

The amount of waterborne film-forming resin in the waterborne effect coating composition depends upon the use of the composition. Generally, the amount of waterborne film-forming resin in the waterborne effect coating composition is greater than 50% by weight, based on the total weight of the carboxyalkyl cellulose ester and the waterborne film-forming resin.

The amount of effect pigment present in the waterborne effect coating composition of the present invention will depend upon the appearance desired for the final coating film. In one embodiment of the invention, the waterborne effect coating composition will include in the range of about 1.0 to about 30 weight percent of effect pigment based on the total solids of the waterborne effect coating composition. The effect pigment may be either metallic or non-metallic in nature. Suitable metallic effect pigments include, but are not limited to, aluminum, bronze, stainless steel, and nickel. In one especially preferred embodiment, the metallic effect pigment is an aluminum flake pigment. Suitable non-metallic effect pigments include mica, metal oxide-coated mica, and metal oxide-coated borosilicate. If desired, the waterborne effect coating composition can also include typical organic and inorganic pigments that are well-known to one of ordinary skill in the art of surface coatings, especially those set forth by the Colour Index, 3d Ed., 2d Rev., 1982, published by the Society of Dyers and Colourists in association with the American Association of Textile Chemists and Colorists. Examples include, but are not limited to the following: CI Pigment White 6 (titanium dioxide); CI Pigment Red 101 (red iron oxide); CI Pigment Yellow 42, CI Pigment Blue 15, 15:1, 15:2, 15:3, 15:4 (copper phthalocyanines); CI Pigment Red 49:1; and CI Pigment Red 57:1.

The waterborne effect coating composition can further comprise at least one solvent. The solvent can be any that are known in the art.

In addition, such waterborne effect coating compositions may further comprise one or more typical coatings additives such as leveling, rheology, and flow control agents (e.g., silicones, fluorocarbons or cellulosics); associative thickeners; flatting agents; pigment wetting and dispersing agents and surfactants; ultraviolet (“UV”) absorbers; UV light stabilizers; tinting pigments; defoaming and antifoaming agents; anti-settling, anti-sag, and bodying agents; anti-skinning agents; anti-flooding and anti-floating agents; fungicides and mildewcides; corrosion inhibitors; thickening agents; or coalescing agents.

The amount of such additives in the waterborne effect coating composition varies depending on the use of the waterborne effect coating compositions. In one embodiment of the invention, the amount of additives ranges from about 0.1 wt % to 15 wt % based on the total weight of the waterborne effect coating composition.

The waterborne effect coating composition of the present invention may further be coated onto a substrate to yield a coated article. The substrate may be plastic, metal, or wood. The substrate may have been pretreated with additives or coatings to provide for adequate adhesion of the waterborne effect coating composition to the substrate.

The waterborne effect coating composition of the present invention may be subsequently coated with a topcoat or clearcoat composition. The topcoat or clearcoat composition may be thermoplastic or thermosetting. The topcoat or clearcoat composition may be a solventborne, waterborne, powder, or a 100% solids UV coating composition.

This invention can be further illustrated by the following examples of preferred embodiments thereof, although it will be understood that these examples are included merely for purposes of illustration and are not intended to limit the scope of the invention unless otherwise specifically indicated.

### EXAMPLE 1

A 19% solids carboxylalkyl cellulose ester solution was prepared as follows. A mixture of 48.6 g of ethylene glycol monobutyl ether (Eastman EB solvent), 32.4 g of demineralized water, and 1.81 g of N,N-dimethylethanol amine was placed into a metal beaker agitated on a high-speed Dispermat disperser equipped with a serrated blade. With high shear mixing, 19 g of Eastman CMCAB 641-0.2 were added incrementally over about 2 minutes. The resulting mixture was agitated at high shear until the CMCAB was fully dissolved, typically 30 minutes. The resulting CMCAB solution was clear and viscous and had a pH in the range of 7-8.

### EXAMPLE 2

Waterborne effect coating compositions were prepared with and without a carboxyalkyl cellulose ester as described in Table 1 below.

TABLE 1

| | | |
|---|---|---|
| Component | Amount (g) | Manufacturer |

Waterborne Metallic Coating - Control

| | | | |
|---|---|---|---|
| (1) | Alberdingk AS 2512 (film-forming resin) | 127.50 | Alberdingk Boley |
| (2) | Premix prior to Adding to (1) | | |
| | Foamex 822 (anti-foam) | 2.40 | Tego/Degussa |
| | Dowanol DPM (solvent) | 21.00 | Dow Chemical Co. |
| | Dowanol DPnB (solvent) | 15.00 | Dow Chemical Co. |
| | Water | 75.00 | |
| | Disparlon AQ 607 (thickener) | 3.00 | King Industries |
| (3) | Premix prior to Adding to Result of (2) | | |
| | Hydrolan 9157 (pigment) | 15.00 | Eckart America |
| | Eastman EB (solvent) | 9.00 | Eastman Chemical Co. |
| | Water | 27.00 | |
| | Disperbyk 192 (pigment dispersant) | 0.60 | Byk Chemie |
| (4) | Add with mixing to Result of (3) | | |
| | Dow Corning 67 (flow additive) | 0.90 | Dow Corning |
| | Viscalex HV30 (thickener) | 3.00 | Ciba Specialty Chemicals |
| | DMEA (neutralizing agent) | 0.60 | Dow Chemicals |
| | Total | 300.00 | |
| | Solids: 25.4% by weight | | |
| | VOC: 174.2 g/l | | |

Waterborne Metallic Coating Containing 3 wt % CMCAB 641-0.2

| | | | |
|---|---|---|---|
| (1) | Alberdingk AS 2512 | 123.68 | Alberdingk Boley |
| (2) | Premix prior to Adding to (1) | | |
| | Foamex 822 | 2.40 | Tego/Degussa |
| | Dowanol DPM | 14.32 | Dow Chemical Co. |
| | Dowanol DPnB | 15.00 | Dow Chemical Co. |
| | Water | 72.50 | |
| | Disparlon AQ 607 | 3.00 | King Industries |
| | CMCAB 641-0.2 solution of Example 1 | 13.00 | Eastman Chemical Co. |
| (3) | Premix prior to Adding to Result of (2) | | |
| | Hydrolan 9157 | 15.00 | Eckart America |
| | Eastman EB | 9.00 | Eastman Chemical Co. |
| | Water | 27.00 | |
| | Disperbyk 192 | 0.60 | Byk Chemie |
| (4) | Add with mixing to Result of (3) | | |
| | Dow Corning 67 | 0.90 | Dow Corning |
| | Viscalex HV30 | 3.00 | Ciba Specialty Chemicals |
| | DMEA | 0.60 | Dow Chemicals |
| | Total | 300.00 | |
| | Solids: 25.4% | | |
| | VOC: 174.2 g/l | | |

### EXAMPLE 3

The waterborne effect coating compositions described in Example 2 were spray applied in two coats to a target dry film thickness of 0.5 mils onto 18″×24″ primed steel panels with a high volume low pressure (HVLP) spray gun under different environmental conditions. The panels were flashed for two minutes between coats. After the second coat, the panels were flashed for an additional two minutes and then dried hanging vertically at 150° F. for 15 minutes. Table 2 describes the appearance of the coated panels in terms of the average face brightness (L* at an angle of 15 degrees aspecular) from 100 data points as collected with an X-Rite MA68II multi-angle spectrophotometer. Standard deviation (n=100, except where noted otherwise) is also reported for these appearance measurements.

TABLE 2

| Application Conditions | | L* @ 15 degrees | | | |
|---|---|---|---|---|---|
| % | temperature | | std dev | | std dev |
| humidity | ° F. | CMCAB | +/− | control | +/− |
| 60 | 69 | 137.6 ¹ | 1.9 ¹ | 130.0 | 1.3 |
| 70 | 70 | 136.9 ² | 1.9 ² | 126.2 | 0.5 |
| 70 | 85 | 139.2 | 1.9 | 132.2 | 1.6 |
| 86 | 82 | 137.9 | 0.9 | 125.1 | 1.2 |

¹ n = 25;
² n = 75

The sensitivity of the appearance properties to application conditions can be gauged by averaging the face brightness data presented in Table 2 and evaluating the standard deviation of those averages. A lower standard deviation in this average appearance across application conditions would imply less variability in the appearance as the application conditions changed. This data is reported in Table 3. One immediately notices that the average face brightness across the range of application conditions was significantly improved with the addition of the carboxyalkyl cellulose ester. It is, however, of particular interest that the variability in this key appearance attribute with varying application temperature and humidity was significantly reduced for the waterborne effect coating compositions containing the carboxylalkyl cellulose ester relative to the control as evidenced by the lower standard deviation of this average face brightness.

TABLE 3

Avg. L* @ 15 degrees across Temp/
Humidity Range from Table 2

| | CMCAB | control |
|---|---|---|
| L* @ 15 degrees | 137.9 | 128.3 |
| std dev +/− | 0.9 | 3.3 |

### EXAMPLE 4

Waterborne effect coating compositions were prepared with and without a carboxyalkyl cellulose ester as described in Table 4 below.

TABLE 4

| | | |
|---|---|---|
| Component | Amount (g) | Manufacturer |

Waterborne Metallic Coating - Control

| | | | |
|---|---|---|---|
| (1) | Macrynal VXM 6285 (film-forming resin) | 33.47 | UCB Surface Specialties |
| | Maprenal MF900/95 (crosslinking resin) | 6.44 | UCB Surface Specialties |
| | Eastman EB (solvent) | 5.60 | Eastman Chemical |
| (2) | Premix prior to Adding to (1) | | |
| | Viacryl VSC 6279W (film-forming resin) | 7.06 | UCB Surface Specialties |
| | Water | 11.39 | |
| (3) | Premix prior to Adding to Result of (2) | | |
| | Viscalex HV30 (thickener) | 5.62 | Ciba Specialty Chemicals |
| | Water | 4.55 | |
| (4) | Premix prior to Adding to Result of (3) | | |
| | Laponite RD (rheology control agent) | 0.23 | Southern Clay |
| | Water | 7.01 | |
| (5) | Add with mixing to Result of (4) | | |
| | Foamex 825 | 0.23 | Tego/Degussa |
| | 10% DMEA in water (neutralizing agent) | 1.64 | |
| (6) | Premix prior to Adding to Result of (5) | | |
| | Hydrolan 8154 (aluminum pigment) | 7.06 | Eckart America |
| | Additol XL250 (pigment dispersant) | 0.68 | UCB Chemicals |
| | Eastman EB (solvent) | 6.69 | Eastman Chemical Co. |
| | N-methyl pyrrolidone (solvent) | 2.32 | |
| | Solids: 29.1% by weight | | |
| | VOC: 474 g/l | | |

Waterborne Metallic Coating containing 6 wt % CMCAB 641-0.2

| | | | |
|---|---|---|---|
| (1) | Macrynal VXM 6285 | 29.31 | UCB Surface Specialties |
| | Maprenal MF900/95 | 6.10 | UCB Surface Specialties |
| | Eastman EB | 2.84 | Eastman Chemical |
| (2) | Premix prior to Adding to (1) | | |
| | Viacryl VSC | 6.18 | UCB Surface Specialties |
| | Water | 9.97 | |
| (3) | Premix prior to Adding to Result of (2) | | |
| | Viscalex HV30 | 3.99 | Ciba Specialty Chemicals |
| | Water | 3.99 | |
| (4) | Premix prior to Adding to Result of (3) | | |
| | Laponite RD | 0.20 | Southern Clay |
| | Water | 6.14 | |
| (5) | Add with mixing to Result of (4) | | |
| | Foamex 825 | 0.20 | Tego/Degussa |
| | 10% DMEA in water | 1.23 | |
| (6) | Add with mixing to Result of (5) | | |
| | CMCAB 641-0.2 solution of Example 1 | 6.77 | Eastman Chemical Co. |
| | Water | 7.98 | |
| (7) | Premix prior to Adding to Result of (6) | | |
| | Hydrolan 8154 | 6.62 | Eckart America |
| | Additol XL250 | 0.60 | UCB Chemicals |
| | Eastman EB | 5.86 | Eastman Chemical Co. |
| | N-methyl pyrrolidone | 2.03 | |
| | Solids: 27.4% by weight | | |
| | VOC: 474 g/l | | |

### EXAMPLE 5

The waterborne effect coating compositions described in Example 4 were spray applied in two coats to a target dry film thickness of 0.6 mils onto 18″×24″ primed steel panels using a RMA 303 indirect charge rotary atomizer that was equipped with a 0.062 fluid tip and a 65 mm serrated bell cup under different environmental conditions. The panels were flashed for two minutes between coats. After the second coat, the panels were flashed for an additional five minutes and then dried hanging vertically at 140° F. for 10 minutes, then an additional 30 minutes at 284° F. Table 5 describes the appearance of the coated panels in terms of the average face brightness (L* at an angle of 15 degrees aspecular) from 100 data points as collected with an X-Rite MA68II multi-angle spectrophotometer. Standard deviation (n=100) is also reported for these appearance measurements. The face brightness of the waterborne effect coating compositions containing carboxyalkyl cellulose ester illustrated a significant improvement over the control formulation when both are applied at the “standard” conditions (i.e. 75° F. and 65% relative humidity).

TABLE 5

| Application Conditions | | L* @ 15 degrees | | | |
|---|---|---|---|---|---|
| % | temperature | | std dev | | std dev |
| humidity | ° F. | CMCAB | +/− | control | +/− |
| 50 | 82 | 127.9 | 1.4 | 127.3 | 1.4 |
| 65 | 75 | 127.7 | 1.3 | 123.5 | 0.3 |
| 80 | 68 | 129.0 | 1.3 | 130.9 | 0.8 |

The sensitivity of the appearance properties to application conditions can be gauged by averaging the face brightness data presented in Table 5 and evaluating the standard deviation of those averages. A lower standard deviation in this average appearance across application conditions would imply less variability in the appearance as the application conditions changed. This data is reported in Table 6. The waterborne effect coating composition containing the carboxyalkyl cellulose ester clearly demonstrated reduced variability in appearance relative to the control formulation across the ranges of temperature and humidity tested.

TABLE 6

Avg. L* @ 15 degrees across Temp/
Humidity Range from Table 5

| | CMCAB | control |
|---|---|---|
| L* @ 15 degrees | 128.2 | 127.2 |
| std dev +/− | 0.6 | 3.0 |

The invention has been described in detail with particular reference to preferred embodiments thereof, but it will be understood that variations and modifications can be effected within the spirit and scope of the invention.

That which is claimed is:

1. A method for improving the consistency of appearance of a waterborne effect coating composition comprising:
maintaining the temperature of an application environment within a range of from about 50° F. to about 90° F.;
maintaining the relative humidity of the application environment within a range of from about 40% to about 90%; and
applying to a substrate said waterborne effect coating composition; wherein said waterborne effect coating composition comprises at least one waterborne film-forming resin, at least one effect pigment, and at least one carboxyalkyl cellulose ester.

2. The method of claim 1 wherein said temperature of said application environment is within a range of from about 65° F. to about 85° F.

3. The method of claim 1 wherein said relative humidity of said application environment is within a range of from about 50% to about 80%.

4. The method of claim 1 wherein said applying of said waterborne effect coating composition to the substrate is conducted by spraying said waterborne effect coating composition.

5. The method of claim 4 wherein said spraying is carried out using at least one device selected from the group consisting of an air atomized spray device, an electrostatic air atomized spray device, an electrostatic rotary atomizing device, and an airless spray device.

6. The method of claim 1 wherein said waterborne effect coating composition comprises:
about 0.1 to about 50 weight percent of a carboxyalkyl cellulose ester based on the total weight of said carboxyalkyl cellulose ester and said waterborne film-forming resin;
wherein at least about 25 percent of all free carboxyl groups on said carboxyalkyl cellulose ester have been neutralized with ammonia or an amine;
at least 50 weight percent of said waterborne film-forming resin, based on the total weight of said carboxyalkyl cellulose ester and said waterborne film forming resin;
about 1 to about 30 weight percent of said effect pigment, based on the total weight of (a) and (b) of said at least one effect pigment;
water; and
an organic solvent.

7. A method according to claim 1 wherein said carboxyalkyl cellulose ester comprises carboxy(C₁-C₃ alkyl) cellulose esters.

8. A method according to claim 7 wherein said carboxyalkyl cellulose ester has an inherent viscosity of about 0.20 dL/g to about 0.70 dL/g, as measured in a 60/40 (wt./wt.) solution of phenol/tetrachloroethane at 25° C.

9. A method according to claim 7 wherein said carboxyalkyl cellulose ester has a degree of substitution per anhydroglycose unit of carboxy(C₁-C₃ alkyl) of about 0.20 to about 0.75, and a degree of substitution per anhydroglucose unit of C₂-C₄ esters of about 1.5 to about 2.7.

10. A method according to claim 1 wherein said carboxyalkyl cellulose ester comprises carboxymethyl cellulose butyrate having a degree of substitution per anhydroglucose unit of carboxymethyl of about 0.20 to about 0.75, a degree of substitution per anhydroglucose unit of hydroxyl from about 0.10 to about 0.70, and a degree of substitution per anhydroglucose unit of butyryl of about 1.50 to about 2.70, and having an inherent viscosity of about 0.20 to about 0.70 dL/g, as measured in a 60/40 (wt./wt.) solution of phenol/tetrachloroethane at 25° C.

11. A method according to claim 10 wherein said carboxymethyl cellulose butyrate has an inherent viscosity ranging from about 0.35 to about 0.60 dL/g.

12. A method according to claim 1 wherein said carboxyalkyl cellulose ester comprises carboxymethyl cellulose propionate having a degree of substitution per anhydroglucose unit of carboxymethyl of about 0.20 to about 0.75, a degree of substitution per anhydroglucose unit of hydroxyl from about 0.10 to about 0.70, and a degree of substitution per anhydroglucose unit of propionyl of about 1.50 to about 2.70, and having an inherent viscosity of about 0.20 to about 0.70 dL/g, as measured in a 60/40 (wt./wt.) solution of phenol/tetrachloroethane at 25° C.

13. A method according to claim 12 wherein said carboxymethyl cellulose propionate has an inherent viscosity ranging from about 0.35 to about 0.60 dL/g.

14. A method according to claim 1 wherein said carboxyalkyl cellulose ester comprises carboxymethyl cellulose acetate butyrate having a degree of substitution of carboxymethyl of about 0.20 to about 0.75, a degree of substitution per anhydroglucose unit of hydroxyl from about 0.10 to about 0.70, and a degree of substitution per anhydroglucose unit of butyryl of about 0.10 to about 2.60 and a degree of substitution per anhydroglucose unit of acetyl of about 0.10 to about 1.65, and having an inherent viscosity of about 0.20 to about 0.70 dL/, as measured in a 60/40 (wt./wt.) solution of phenol/tetrachloroethane at 25° C.

15. A method according to claim 14 wherein said carboxymethyl cellulose acetate butyrate has a degree of substitution per anhydroglucose unit of hydroxyl is 0.10 to 0.70, butyryl is 1.10 to 2.55, and acetyl is 0.10 to 0.90.

16. A method according to claim 1 wherein said carboxymethyl cellulose acetate propionate has a degree of substitution per anhydroglucose unit of carboxymethyl of 0.20 to 0.75, a degree of substitution per anhydroglucose unit of hydroxyl from about 0.10 to 0.70, a degree of substitution per anhydroglucose unit of propionyl of about 0.10 to 2.60 and a degree of substitution per anhydroglucose unit of acetyl of about 0.10 to 2.65, and having an inherent viscosity of 0.20 to 0.70 dL/g, as measured in a 60/40 (wt./wt.) solution of phenol/tetrachloroethane at 25° C.

17. A method according to claim 16 wherein said carboxymethyl cellulose acetate propionate has the degree of substitution per anhydroglucose unit of hydroxyl is 0.10 to 0.70, butyryl is 1.10 to 2.55, and acetyl is 0.10 to 0.90.

18. The method of claim 1 wherein said at least one waterborne film-forming resin is a water-soluble or water-dispersible resin selected from the group consisting of an acrylic polymer, a styrene-acrylic polymer, a polyurethane, a polyester, an alkyd, an acrylic-modified polyurethane, an acrylic-modified polyester, an acrylic-modified alkyd, and an epoxy.

19. The method of claim 1 wherein said at least one effect pigment is selected from the group consisting of metallic effect pigment and non-metallic effect pigment.

20. The method of claim 19 wherein said metallic effect pigment is selected from the group consisting of aluminum, copper, bronze, stainless steel, nickel, and silver.

21. The method of claim 20 wherein said metallic effect pigment is aluminum.

22. The method of claim 19 wherein said non-metallic effect pigment is selected from the group consisting of mica, metal oxide-coated mica, and metal oxide-coated borosilicate.

23. The method of claim 1 wherein said waterborne effect coating composition further comprises at least one crosslinking agent.

24. The method of claim 1 wherein said waterborne effect coating composition further comprises from about 0.1 to about 15 weight percent, based on the total weight of the waterborne effect coating composition, of one or more coatings additives selected from the group consisting of leveling, rheology, and flow control agents; flatting agents; pigment wetting and dispersing agents; surfactants; ultraviolet (UV) absorbers; UV light stabilizers; tinting pigments; defoaming and antifoaming agents; anti-settling, anti-sag and bodying agents; anti- skinning agents; anti-flooding and anti-floating agents; fungicides and mildewcides; corrosion inhibitors; thickening agents; or coalescing agents.

25. The method of claim 1 wherein said waterborne effect coating composition is subsequently coated with a topcoat or clearcoat composition.
